(19) United States
(12) Patent Application Publication
(10) Pub. No.: US 2017/0252933 A1
(43) Pub. Date: Sep. 7, 2017

(54) PERSONAL SHAVER

(71) Applicant: Jami Bolduc, Baxter, MN (US)

(72) Inventor: Jami Bolduc, Baxter, MN (US)

(21) Appl. No.: 15/365,454

(22) Filed: Nov. 30, 2016

Related U.S. Application Data
(63) Continuation of application No. 29/556,670, filed on Mar. 2, 2016.

(51) Int. Cl. B26B 21/40; B26B 21/44; B26B 21/52; B26B 21/06; B26B 21/22

(52) U.S. Cl. CPC B26B 21/4031; B26B 21/4081; B26B 21/06; B26B 21/225; B26B 21/522; B26B 21/443

(57) ABSTRACT

A disposable razor comprising a handle and a razor blade head casing configured to receive a plurality of individual razor blades, wherein each razor blade has a different width along an exposed sharp edge of the blade and wherein the plurality of razor blades are spaced apart and secured in the casing in a parallel orientation. The casing is substantially triangular in shape and each of the plurality of blades is aligned in the casing by decreasing width such that each razor blade is wider than the razor blade above and adjacent to said blade. The razor comprises four blades, ranging in width from about 1.5 inches or less to about 0.7 inches.

### BACKGROUND

The present invention relates to disposable razors. More specifically, the present invention relates to disposable razors having razor blades of varying lengths, providing a tapered razor head.

Disposable razors generally have a rectangular razor head, containing a plurality of blades positioned in parallel. The razor heads have a rectangular shape for easily shaving large areas. The size and shape of razor heads are further enlarged by the inclusion of soaps and/or lotions in strips surrounding the blades. These razors are limited in the areas in which they can effectively be used and efficiently remove hair.

### SUMMARY OF THE INVENTION

An aspect of the present disclosure relates to a multi-blade razor head having blades of decreasing length to provide an overall tapered shape. The tapered razor head may also include medicated material, lotions, soaps or other materials such as aloe surrounding the blades. The razor head may also be fixed to a handle of any shape or length such that the head frame and the handle are a unitary construction. Alternatively, the razor head may be detachable. The razor blade is part of a disposable razor.

The plurality of razor blades comprises razor blades of the same type but having a different width (e.g., extending across the razor head). When securing the blades in the frame, or a casing, of the razor head, the blades are positioned parallel to one another in order of decreasing width such that the overall shape of the razor head is substantially triangular.

Another aspect of the present disclosure relates to a method of using a tapered razor blade to remove hair from delicate areas or small surfaces. The method comprises providing a disposable multi-blade razor head wherein the head comprises a plurality of razor blades of the same type but having a different width (e.g., extending across the razor head). When securing the blades in the frame, or a casing, of the razor head, the blades are positioned parallel to one another in order of decreasing width such that the overall shape of the razor head is substantially triangular and using the razor to remove hair from small surfaces.

### DESCRIPTION OF THE DRAWINGS

FIG. 1 is a top perspective view of a razor having the head of the present disclosure.

FIG. 2 is a bottom perspective view of the razor.

FIG. 3 is a bottom view of the razor head.

### DETAILED DESCRIPTION

The device of the present disclosure is a multiple blade razor having a handle and a removable blade head. The razor blade head has a plurality of razor blades of the same type ad having approximately the same angle shave edge or shave surface but each having different widths. The blades are secured in a razor head casing, or frame, in a parallel fashion to provide a consistent blade surface area of shaving while the casing has an overall generally triangular shape or tapered dimension.

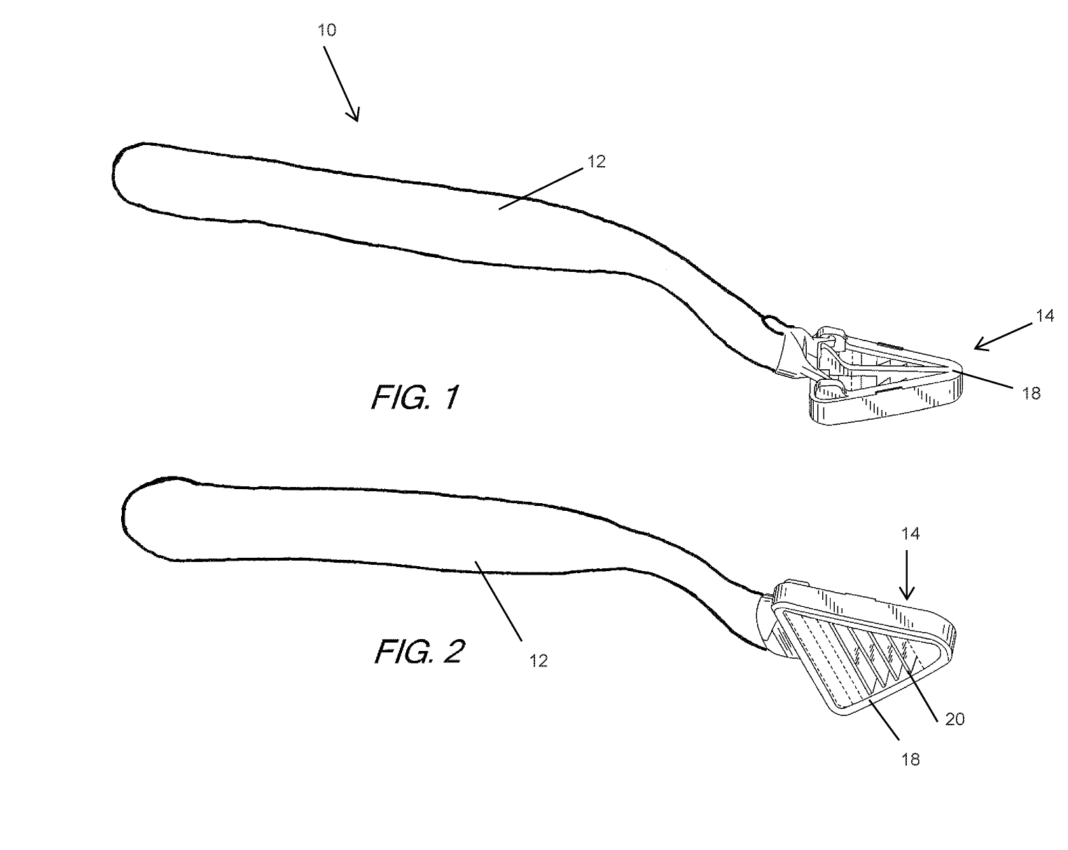

As illustrated generally in FIGS. 1-2 at 10, the handle 12 is a formed hollow cylinder, preferably constructed of a light weight, durable and waterproof material, preferably plastic. The handle may also have a silicon or rubber covering along the handle or in selected areas of the handle according to placement of a hand or fingers when using. The rubber or silicon coating or covering acts to prevent slippage in wet conditions and also provide a comfortable grip.

An upper end 14 of the handle 12 is adapted for connection to or is integrally connected with a base of the blade head 16. The handle 12 may comprise a trigger near the upper end for opening and closing a plurality of projections which engage and connection with a cooperating set of projections on a base of the removable blade head. The trigger is engaged to open the projections on the handle and disengaged to close the projections around those of the blade head. Other suitable mechanisms may be used to allow to the blade head to be easily secured to the handle for use and easily removed when a new blade head is required. Alternatively, the handle 12 and the blade head 16 are a unitary construction such that the razor as a whole is disposable.

The blade head 16 comprises a frame or casing 18 which securely receives a plurality of individual razor blades 20. The frame or casing 18 may be a plastic molding generally in the shape of a triangle, the triangle being substantially an equilateral triangle, however, variations of the triangle shape may be considered to account for different advantages in use and coverage areas. The overall shape of the blade head 14, including the decrease in width near the upper blade and the outer or front end of the molding allows for the razor to be used more effectively in smaller areas or areas where the skin is not smooth. The size and shape of the razor itself no longer prevents the blades from making closer contact with the skin as does the rectangular shape of the razor blades used in the prior art. The triangular shape no longer allows one blade to prevent all of the blades from making contact with the skin or surface for hair removal.

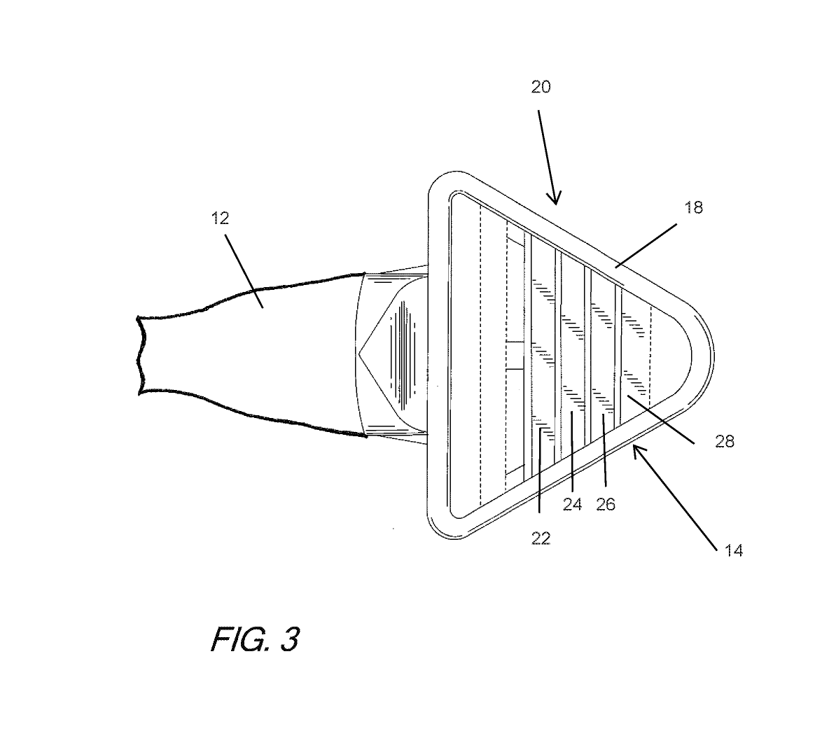

As illustrated in further detail in FIG. 3, the casing 18 securely houses a plurality of blades. The housing may hold anywhere from two to five or more blades. In the embodiment illustrated, the casing secures four blades to the razor. The four individual razor blades each are of the same type, having the same blade angle for shaving. The width of a leading edge, the edge that contacts the skin and faces outwardly when positioned within the casing 18, of the individual blades 20 varies from approximately 1.5 inches to approximately 0.70 inches.

In one embodiment, the blade of greatest width is a lower blade 22, positioned at a base end of the casing 18 proximate the handle 12. The blades 20 each decrease in width along the respective leading edge such that the upper-most blade 20, the distal blade 28 has the least width. For example, the blades may comprise lower blade 22 having a leading edge width between about 1.2 inches and about 1.25 inches, or for example, may have a width of approximately 1.220 inches; a second blade 24 adjacent and parallel to the lower blade 22 may have a leading edge width between about 1.05 inches and 1.08 inches, or for example, a width of approximately 1.061 inches; an adjacent blade, a third blade 26 may then have a leading edge width between about 0.8 inch and about 1.0 inch, or for example, a width of approximately 0.900 inches and the upper most blade 28 may have a leading edge width between about 0.7 inches and about 0.8 inches, or for example, a width of approximately 0.739 inches.

The individual blades are arranged in the casing 18 by alignment of the approximate mid-width or center of each blade 22, 24, 26, 28. Thus the plurality of blades 20 are positioned in the casing 18 with the widest blade 22 proximate the bottom of the casing 18 and the shortest blade 28 proximate the top of the casing, thus the casing terminates in an apex that is linearly aligned with and in the direction of the handle 12. The middle blades 24 and 26 also correspondingly decrease in width such that each lower blade is wider than the blades above it.

The razor blades 20 are secured in the casing 18 proximate a side edge and/or a back side edge of each blade. The blades are positioned in parallel orientation with respect to the sharp leading or cutting edge of each blade so as to allow for efficient hair removal. The sharp leading edge ma have a standard angle similar to the angle or grade of most razor blades for shaving.

The casing 18 may also have moisturizing and/or lubricating strips positioned along the outer edges of the casing 18. The strips can be positioned along the outer edge of the casing 18 proximate the lower blade 22 and/or the upper most blade 28. The strips are preferably a water soluble form of moisturizer, such as an aloe containing product, and when exposed to water, the moisturizing strips as positioned will aid the blades in gliding more easily over a user's skin for ease of hair removal.

Although the present invention has been described with reference to preferred embodiments, workers skilled in the art will recognize that changes may be made in form and detail without departing from the spirit and scope of the invention.

What is claimed:

1. A disposable razor comprising:
a handle; and
a razor blade head comprising a casing configured to receive a plurality of individual razor blades, wherein each razor blade has a different width along an exposed sharp edge of the blade; and
wherein the plurality of razor blades are spaced apart and secured in the casing in a parallel orientation such that the casing is substantially triangular in shape and wherein each of the plurality of blades is aligned in the casing by decreasing width such that each razor blade is wider than the razor blade above and adjacent to said blade.

2. The razor of claim 1, wherein the handle and razor blade head are a unitary construction.

3. The razor of claim 1, wherein the plurality of blades comprises four blades.

4. The razor of claim 1, wherein the casing and handle are comprised of plastic.

5. The razor of claim 4, wherein the casing is adapted with one of a lotion, soap or aloe based shaving aid.

6. The razor of claim 1, where in the width of the blade is measured by the width of the sharp, skin surface engaging edge and wherein the widest blade has a width between about 1.2 inches and about 1.25 inches.

7. The razor of claim 6, wherein the least wide blade has a width between about 0.7 inches and 0.8 inches.

8. The razor of claim 3, wherein the width of the individual blades varies from approximately 1.5 inches to approximately 0.70 inches.

9. A method of removing hair from an uneven surface or small area comprising:
providing a disposable razor comprising a handle and a razor blade head casing configured to receive a plurality of individual razor blades, wherein each razor blade has a different width along an exposed sharp edge of the blade and wherein the plurality of razor blades are spaced apart and secured in the casing in a parallel orientation such that the casing is substantially triangular in shape and wherein each of the plurality of blades is aligned in the casing by decreasing width such that each razor blade is wider than the razor blade above and adjacent to said blade;
engaging the exposed sharp edges of the razor blades with an uneven surface or small surface area and removing the hair.

10. The method of claim 9, wherein the casing and handle are comprised of plastic.

11. The method of claim 9, wherein the casing is adapted with one of a lotion, soap or aloe based shaving aid.

12. The method of claim 9, where in the width of the blade is measured by the width of the sharp, skin-surface engaging edge and wherein a first blade has a width of about 1.220 inches.

13. The method of claim 12, wherein a second blade has a width of about 1.061 inches.

14. The method of claim 13, wherein a third blade has a width of about 0.900 inches.

15. The method of claim 14, wherein a four blade has a width of about 0.739 inches.
